(19) United States
(12) Patent Application Publication
(10) Pub. No.: US 2006/0019214 A1
(43) Pub. Date: Jan. 26, 2006

(54) Compact tooth whitening device

(76) Inventors: Eric S. Lawrence, Mayfield Heights, OH (US); Michael DuBois, Brooklyn Heights, OH (US); Paul Mehes, Novelty, OH (US)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 11/189,569

(22) Filed: Jul. 26, 2005

Related U.S. Application Data
(60) Provisional application No. 60/591,267, filed on Jul. 26, 2004.

(51) Int. Cl. A61C 3/00; A61C 5/00

(52) U.S. Cl. 433/29; 433/215; 433/80

(57) ABSTRACT

The present invention relates to compact tooth whitening devices. The compact tooth whitening device includes an electromagnetic radiation source and an applicator that is removably attached. A tooth whitening agent may be placed in the applicator and applied to the user's teeth. The electromagnetic radiation source is activated to impart electromagnetic radiation to the surface of the user's teeth coated with the tooth whitening agent, thereby causing a chemical reaction with the whitening agent, the effect of which is to enhance and/or expedite the tooth whitening effect of the application. In one embodiment of the present invention, the tooth whitening agent is selected based upon the wavelength of electromagnetic radiation emitted from the electromagnetic radiation emitter. In another aspect of the invention, a “try me package” is provided to allow consumers to sample the invention on a treated portion of the product packaging.

### RELATED APPLICATION DATA

This application claims the benefit of U.S. Provisional Application No. 60/591,267, filed Jul. 26, 2004, which is incorporated herein by reference.

### BACKGROUND OF THE INVENTION

1. Technical Field

The present invention relates generally to dental hygiene and more particularly to systems and methods for tooth whitening using a whitening agent and electromagnetic radiation provided by a compact electronic device to enhance and/or expedite the tooth whitening process.

2. Description Of The Related Art

In the past, tooth whitening was the sole province of the professional dentist. Professional tooth whitening typically involves a dentist applying a concentrated dose of a teeth whitening agent to the surface of the patient's teeth. The application of the tooth whitening agent is typically performed with the use of a dental tray (e.g., a mouthpiece), which has a reservoir for holding the whitening agent. The precise dosage of the tooth whitening agent (e.g., hydrogen or carbamide peroxide), generally ranges from about 10% to 35% depending upon the precise whitening agent being used. Due to the high concentrations of whitening agents used, special care is required to prevent exposure of the whitening agents to the soft tissue in the patient's mouth (e.g., the patient's gums, tongue and ingestion into the patient's digestive track).

While the patient's teeth are exposed to the tooth whitening agent, oftentimes an expensive, bulky, and high intensity device is attached to the dental tray in order to apply an electromagnetic field to the patient's teeth in order to expedite and/or enhance the chemical reaction of the whitening agent. The high intensity energy field may be applied in many forms (e.g., carbon dioxide lasers, infrared lasers, halogen lamps, and various heat producing sources). Typically, each of these sources for the intensity electromagnetic field are impractical for home use for a variety of reasons, including expense, lack of training, potential danger of inadvertent exposure, and the high voltage requirements typically associated with such a device.

An advantage associated with professional tooth whitening is that the results are typically much better than over-the-counter kits (discussed below). It is not uncommon for profession tooth cleaning to improve a patient's tooth color by up to 12 to 15 shades of whitening, as judged by the Vita Lumin Shade Guide. In addition, professional tooth cleaning provides the dentist the opportunity to tailor a tooth whitening program on a patient by patient basis. For instance, the dentist may vary the appropriate concentration of the whitening agent to be applied to the patient. In addition, the dentist may supervise the patient's treatment and provide alternatives should complications with the tooth whitening procedure, such as a patient developing sensitivity to the tooth whitening agent and/or damage to the soft-tissue in the patient's mouth. Disadvantages associated with professional tooth whitening include costs, oftentimes ranging in the $400-$1200 for a single tooth whitening application and the inconvenience of taking time out of the patient's day to visit a dentist.

Over the past few years, consumers are increasingly turning to over-the-counter tooth whitening products for home use. Several available methods utilize a tooth whitening agent, alone or in combination with other agents, in an attempt to whiten teeth. In some methods, the whitening agent is applied to teeth by brushing the teeth with a dentifrice, such as a paste, gel, liquid, cream, or powder, containing the whitening agent. In other methods, dental trays (e.g., mouthpieces) are employed. In these methods, a tooth whitening agent is deposited on a reservoir located on the dental tray, the dental tray is pressed onto the user's teeth, and the whitening agent is permitted to bathe or coat the teeth. In another method, dental strips are applied to the user's teeth, either individually or collectively. While these over-the-counter tooth whitening products are less expensive than professional tooth whitening, they are also less effective. Generally, over-the-counter tooth whitening products require substantially more time (e.g., weeks of repeated applications) than professional tooth whitening and the results generally show only about 5-8 shade improvement in tooth color, as judged by the Vita Lumin Shade Guide.

Accordingly, there remains a strong need for a system and method for whitening teeth that does not require professional supervision, is inexpensive to manufacture, is easy for the consumer to use, can be performed within the confines of the home or at any convenient place, provides professional results, and is less time consuming than conventional over-the-counter tooth whitening products.

### SUMMARY OF THE INVENTION

The present invention is directed to a compact tooth whitening device including a tooth whitening agent.

Another aspect of the present invention is a compact tooth whitening device including: a compact electromagnetic radiation source including a body, at least one electromagnetic radiation emitter and a power supply; and an applicator for placing a tooth whitening agent on at least one tooth of an associated user, wherein the applicator allows electromagnetic energy generated by the at least one electromagnetic radiation emitter to permit a reaction with the tooth whitening agent in order to whiten the at least one tooth of the associated user.

Another aspect of the present invention is a tooth whitening method including: depositing a tooth whitening agent on an applicator; securing the applicator in an associated user's mouth, whereby the applicator coats at least one tooth desired to be whitened; securing a compact electromagnetic radiation source to the applicator, wherein the compact electromagnetic radiation source includes at least one electromagnetic radiation emitter and a power supply; and exposing the at least one tooth desired to be treated with electromagnetic radiation generated from the at least one electromagnetic radiation emitter, wherein the applicator permits the electromagnetic radiation generated by the at least one electromagnetic radiation emitter to cause a reaction with the tooth whitening agent in order to whiten the at least one tooth of the associated user.

Another aspect of the present invention is a compact tooth whitening device including: a compact electromagnetic radiation source including a body, at least one electromagnetic radiation emitter and a power supply, wherein the electromagnetic radiation emitter emits electromagnetic radiation in a range of wavelengths consisting of 300-700 nanometers; and an applicator for placing a tooth whitening agent on at least one tooth of an associated user, wherein the applicator allows electromagnetic energy generated by the at least one electromagnetic radiation emitter to permit a reaction with the tooth whitening agent in order to whiten the at least one tooth of the associated user, wherein the tooth whitening agent is selected based upon the wavelength of electromagnetic radiation emitted from the electromagnetic radiation emitter.

Another aspect of the present invention is a package including an enclosure for securely covering a compact tooth whitening device; an opening on a surface of the enclosure to allow manipulation by at least one hand of a prospective purchaser; and a treated portion of the enclosure being visible to the prospective purchaser, wherein upon exposure to the electromagnetic radiation provided by the electromagnetic radiation emitter, the treated portion of the enclosure becomes lighter than when not exposed to the electromagnetic radiation.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIGS. 1A and 1B are perspective drawings of compact tooth whitening devices in accordance with the present invention;

FIG. 1C is top plan view of a compact tooth whitening device in accordance with the present invention;

FIG. 2A is a perspective view of an electromagnetic radiation source in accordance with another embodiment of the present invention;

FIG. 2B is side profile view of an electromagnetic radiation source in accordance with another embodiment of the present invention;

FIG. 3 is a perspective view of an electromagnetic source in accordance with one aspect of the present invention;

FIGS. 4A-4B are perspective views of electromagnetic radiation sources in accordance with aspects of the present invention;

FIGS. 5A-5C are perspective views of electromagnetic radiation sources in accordance with aspects of the present invention;

FIG. 6 is a perspective view of an electromagnetic radiation source in accordance with one aspect of the present invention;

FIG. 7A is top plan view of a compact tooth whitening device in accordance with one aspect of the present invention;

FIGS. 7B and 7C are front plan views of applicators in accordance with aspects of the present invention;

FIG. 8A is a side plan view of an applicator in accordance with one aspect of the present invention;

FIG. 8B is a front plan view of an applicator in accordance with one aspect of the present invention;

FIG. 9 is a block diagram illustrating a method in accordance with the present invention;

FIG. 10 is a functional block diagram in accordance with one aspect of the present invention; and

FIG. 11 is a perspective view of exemplary product packaging in accordance with the present invention.

### DETAILED DESCRIPTION OF THE INVENTION

In the detailed description that follows, corresponding components have been given the same reference numerals, regardless of whether they are shown in different embodiments or views of the inventions described herein. To illustrate the various aspects of the inventions in a clear and concise manner, the drawings may not necessarily be to scale and certain features may be shown in somewhat schematic form.

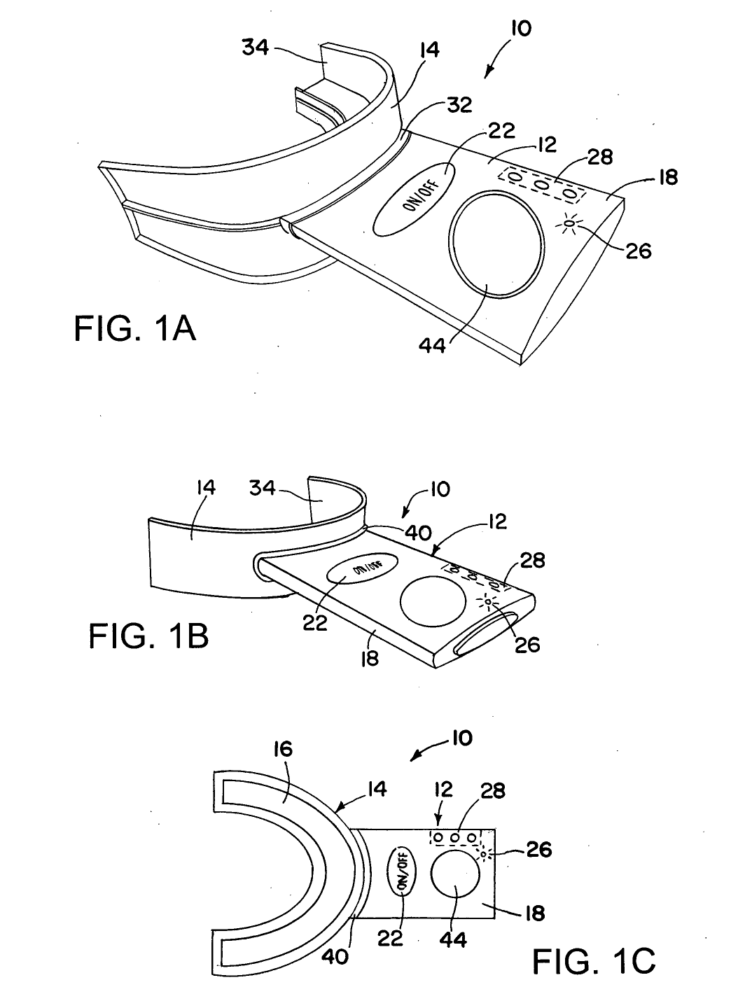

A compact tooth whitening device 10 according to one aspect of the present invention is illustrated in FIGS. 1A-1C. The compact tooth whitening device 10 includes an electromagnetic radiation source 12 and an applicator 14. A whitening agent 16 (shown in FIG. 1C) may be placed in the applicator 14 and applied to the user's teeth. Upon proper placement of the applicator 14 in the user's mouth, the whitening agent 16 bathes or covers the exposed surface of the user's teeth. The electromagnetic radiation source 12 is then directed to the visible portion of the user's teeth, which are exposed to the tooth whitening agent 16. The electromagnetic radiation source 12 is then activated to impart electromagnetic radiation to the surface of the user's teeth coated with the tooth whitening agent 16, thereby causing a chemical reaction with the whitening agent 16, the effect of which is to enhance and/or expedite the tooth whitening effect of the application.

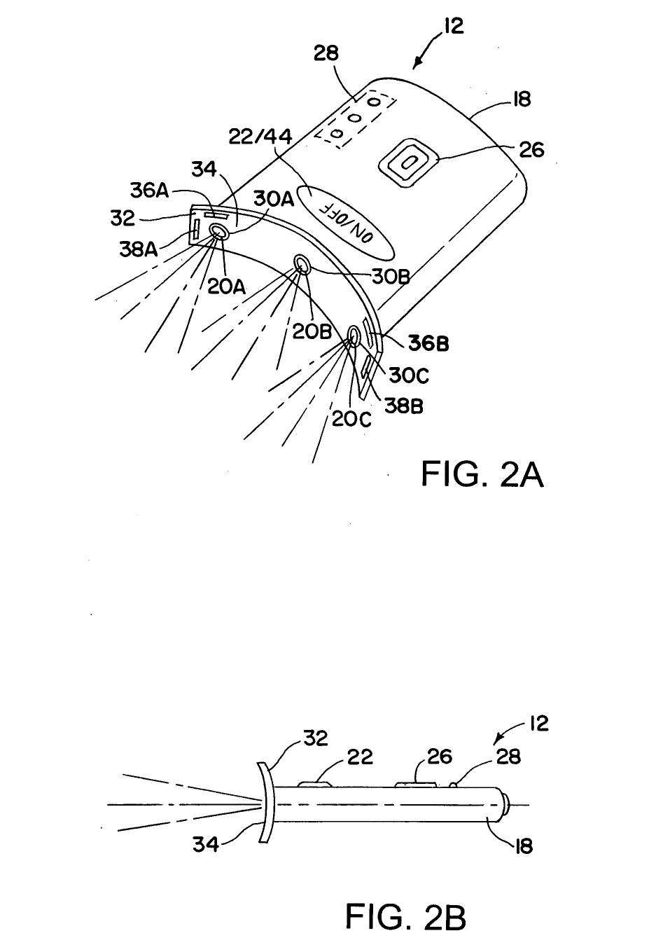

As illustrated in FIG. 2A, the electromagnetic radiation source 12 includes a body 18, at least one electromagnetic radiation emitter(s) 20 (denoted 20A-20C in FIG. 2A), an activation switch 22, a power supply 24 (not shown) and optionally may also include an audible and/or visual indication means, 26 and 28, respectively.

The body 18 may be formed from any type of material (e.g., plastic, metal, or rubber). In one aspect of the invention, the body 18 is formed from a hardened plastic material to fit comfortably in the hand of the user and is resistant to breaking upon impact. In another aspect of the invention, the body 18 is light weight so as to be securely fastened to the applicator 14 in a manner that does not require the user to provide additional support with a hand during use. Preferably, the body 18 is secured to the applicator 14 and supported during use by the user biting down on the applicator 14, thereby engaging the applicator 14 with the user's teeth.

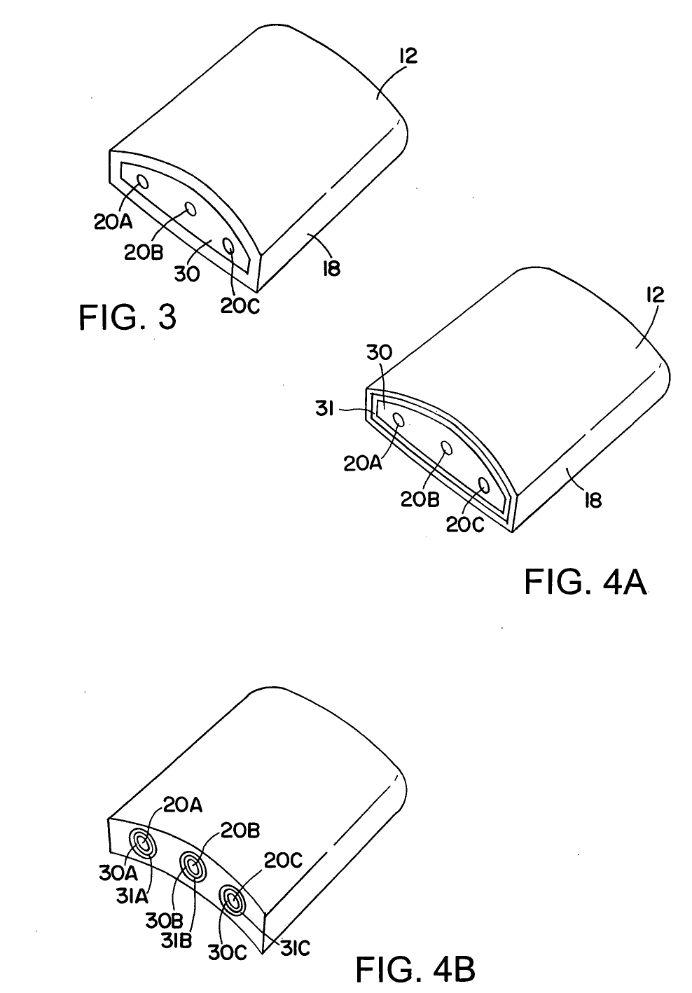

The body 18 also includes at least one portal 30 (denoted 30A-30C in FIG. 2A), which permits the electromagnetic radiation to be emitted to the application area (e.g., the user's teeth coated in a tooth whitening agent 16). In one embodiment, multiple circular portals (30A-30C) are provided, as shown in FIG. 2A. The number of portals 30 generally coincides with the number of electromagnet radiation emitter(s) 20. In another embodiment, shown in FIG. 3, a single rectangular shaped portal 30 is provided, which covers all of the electromagnetic radiation emitters 20. As shown in FIGS. 4A and 4B, a light diffuser 31 may be optionally provided to cover the electromagnetic radiation emitter(s) 20. As shown in FIG. 4A, the light diffuser 31 may cover multiple electromagnetic emitters 20A-20C, or multiple light diffusers (31A-31C) may be used to separately cover electromagnetic emitters 20A-20C, as shown in FIG. 4B. The light diffuser 31 is typically a transparent or semi-transparent material that diffuses electromagnetic radiation from the electromagnetic emitter(s) 20 and provides a substantially uniform spread of light intensity over the entire diffuser layer 31.

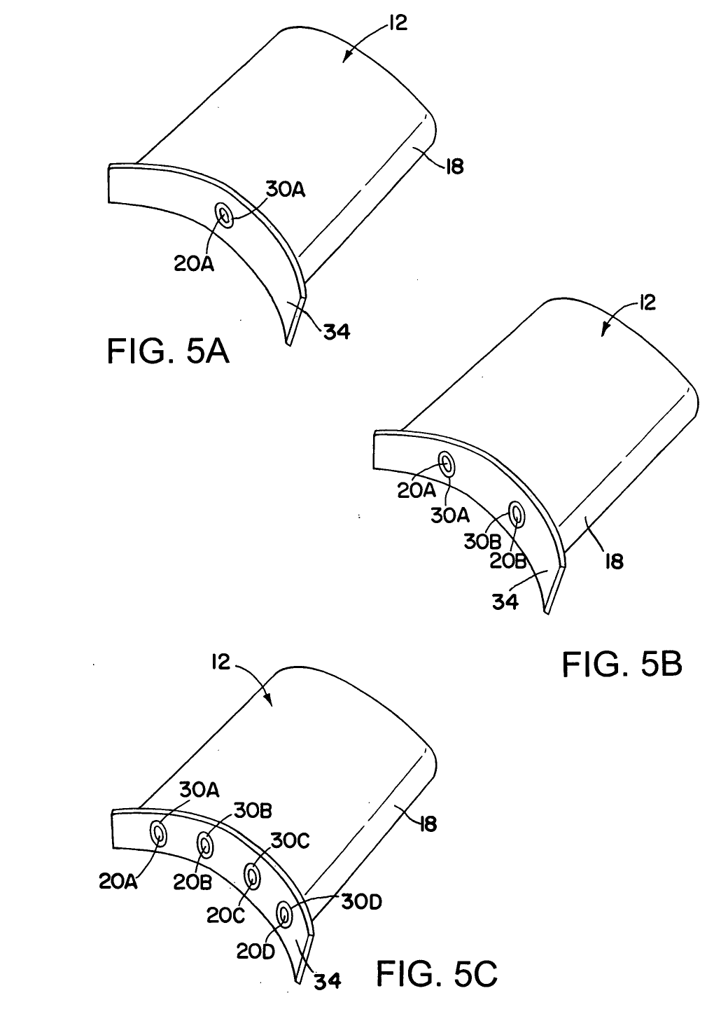

As stated above, the portal 30 provide a passageway for the electromagnetic radiation transmitted by the electromagnetic radiation emitter 20 to enter the applicator 14. The electromagnetic radiation emitter(s) 20 of the present invention may take a variety of forms (e.g., a halogen light, a light emitting diode (LED), a laser, or other such device). As shown in FIG. 2A, the electromagnetic radiation emitter 20 includes electromagnetic radiation emitters (20A-20C). One of ordinary skill in the art will readily appreciate that various types of electromagnetic radiation emitters 20 are within the scope of the present invention. For example, the wavelength of the electromagnetic radiation emitter 20 may be wide band; the electromagnetic radiation emitter 20 may be made of any commercially available material suitable for acting as an electromagnetic radiation emitter. In addition, various configurations of electromagnetic radiation emitter 20 are within the scope of the present invention. For instance, the electromagnetic radiation emitter(s) 20 may be provided at some predetermined distance. For example, as shown in FIGS. 5A-5C, electromagnetic radiation source 12 may also include one electromagnetic radiation emitter 20A, two electromagnetic radiation emitters 20A-20B, and four electromagnetic radiation emitters (20A-20D). The particular spacing of the electromagnetic radiation emitter(s) 20 is determined and chosen, in part, to optimize the desired whitening or cleaning activity provided by the electromagnetic radiation emitted from the electromagnetic radiation emitter(s) 20 and the whitening agent 16.

In addition, although not illustrated, the present invention also includes using fiber optics to expose a portion or the entire applicator 14 with electromagnetic radiation supplied from one or more electromagnetic radiation emitters 20.

One aspect of the invention is keep the costs associated with manufacturing such device low. As the number of the electromagnetic radiation emitter(s) 20 increases, so does the cost to manufacture the electromagnetic radiation source 12. Accordingly, it is desirable to provide the least amount of electromagnetic radiation emitters 20 possible and still be able to provide electromagnetic radiation in an ample supply to photoinitiate the tooth whitening agent 16. In addition, it is also desirable to provide a uniform field of illumination across all of the teeth exposed to the tooth whitening agent 16. If a uniform field is not provided, one aspect of the present invention seeks to insure that at least the photoinitiation state has been met for each of the user's teeth that have been coated with the whitening agent 16.

The electromagnetic radiation emitters 20 may output electromagnetic radiation at any wavelength that enhances and/or expedites the tooth whitening process. For example, the wavelength provided by the electromagnetic radiation emitter(s) 20 may be in the visible spectrum (i.e., from about 300 nanometers to about 700 nanometers), in the mirror-infrared range (i.e., such as from about 700 nanometers to about 980 nanometers) or in a combination of wavelengths. Preferably, a wavelength of about 400 to 500 nanometers is used. In one aspect of the invention, the wavelength of the electromagnetic radiation emitters 20, is selected depending upon the whitening agent 16 used in a particular application. Preferably, the electromagnetic radiation emitter 20 is an LED that has a narrow wavelength of about 400-500 nanometers and further having a power consumption of about 100-180 milliwatts per LED. The wavelength of the electromagnetic radiation emitter(s) 20 is chosen to optimize the whitening effect of the reactive component of the whitening agent 16. Likewise, the power consumption of the LED(s) is chosen to provide a timed duration of the application that is convenient for the user. For example, the higher the power consumption of the electromagnetic radiation emitter(s) 20, the less time is necessary to complete the tooth whitening application.

A power supply 24 (not shown) is provided to supply power to the electromagnetic radiation source 12. In one aspect of the invention, the power supply 24 is a battery. In another aspect of the invention, the power supply 24 is a rechargeable battery that may be recharged by an alternating current adapter or a base unit (not shown) in which the electromagnetic radiation source 12 rests while not in use in order to recharge the power supply 24. The output voltage of the power supply 24 may vary depending upon the power requirements of the electromagnetic radiation emitter 20. As stated above, the total power used by the electromagnetic radiation emitters 20A-20C is within the range of 400-500 mW (approximately 180 milliwatts per electromagnetic radiation emitter 20A-20C).

The electromagnetic radiation source 12 may optionally include a waveguide 32. The waveguide 32 may be attached to a portion of the body 18 of the electromagnetic radiation source 12. The waveguide 32 may be formed integrally with body 18 or may be removably attached to the body 18. Preferably, the waveguide is removably attached to permit the user to easily clean the exposed portions of the waveguide 32.

As illustrated in FIG. 2A, the waveguide 32 may be curved to approximately match the configuration of a patent's upper and/or lower dental arch. In addition, the waveguide 32 generally includes one or more portals 30 that permit electromagnetic radiation originating from the electromagnetic radiation source 12 to pass through the waveguide 32 to the surface of the patient's teeth that are being treated. The surface 34 of the waveguide 32 is generally highly reflective in order to maximize the total reflection of electromagnetic radiation over the entire treatment surface. In one embodiment, the surface 34 of the waveguide 32 is a mirror. In another embodiment, the surface 34 of the waveguide 32 is a highly polished plastic or metal material that permits a high degree of reflectance of the electromagnetic radiation emitted from the electromagnetic radiation emitter(s) 20.

As shown in FIG. 2A, the waveguide 32 may also include a securing mechanism 36A-36 for securing the waveguide 32 to the electromagnetic radiation source 12 during use. In one embodiment, the securing mechanism 36A-36B includes slots in the waveguide 32 that mate with tabs provided in the body 18 of the electromagnetic radiation source 12 or vice versa.

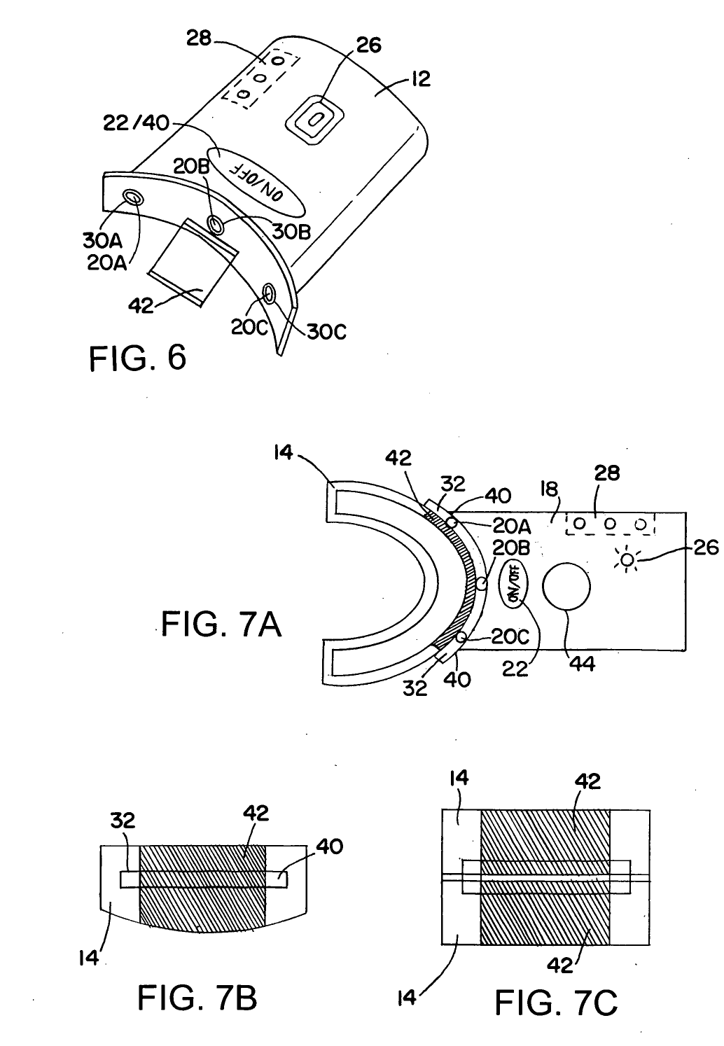

The waveguide 32 may also include a connection mechanism 38A-38B for connecting the electromagnetic radiation source 12 to the applicator 14, as shown in FIG. 2A. Alternatively, as shown in FIGS. 1A-1C, the applicator 14 may be formed to snugly fit within a receptacle integrally formed in the applicator 14. One of ordinary skill in the art will readily appreciate that there a variety of ways to secure the electromagnetic radiation source 12 to the applicator 14. In another aspect of the invention, the electromagnetic radiation source 12 is not secured to the applicator 14. As shown in FIG. 6, a bite plate 42 is provided for the user to secure with biting on the bite plate 42 with the user's upper and lower front teeth. Preferably the bite piece is made of a transparent material that will not affect the electromagnetic radiation emitted from the electromagnetic radiation emitter(s) 20. The applicator 14 is generally removably attached from either connection mechanism 38A-38B of the waveguide 32 or the electromagnetic radiation source 12 to permit the user to easily clean the applicator without damaging the electromagnetic radiation source 12.

The applicator 14 may take a variety of forms (e.g., a dual mouthpiece (for both upper and lower teeth), a partial mouthpiece (for the upper or lower teeth), a brush, dental strips or dental tape). As shown in FIGS. 1A-1C, the applicator 14 is a mouthpiece. The applicator 14 is configured to fit over a user's teeth. The applicator may be generic (one size fits all) or custom designed. The applicator 14 generally fits within a user's mouth and may cover all of the upper and/or lower teeth or a portion thereof. In one embodiment, the applicator 14 may fit over both the upper and/or lower teeth, as shown in FIG. 1A, or separately over the upper or lower teeth as shown in FIGS. 1B-1C.

The applicator 14 may be manufactured from any suitable material including rubbers and plastics, including, but not limited to polyethylenes, polypropylenes, ethyl vinyl acetates. Applicator 14 may be manufactured by any method. For example, a custom applicator 14 may be made by making an impression of the user's teeth, and may be vacuum or thermoformed over the impression. In order to ensure that the electromagnetic radiation is distributed to all of the user's teeth that have been exposed to the whitening agent 16, the interior portion of the applicator 14 (i.e., the surface of the applicator 14 in contact with the user's teeth) is generally highly reflective.

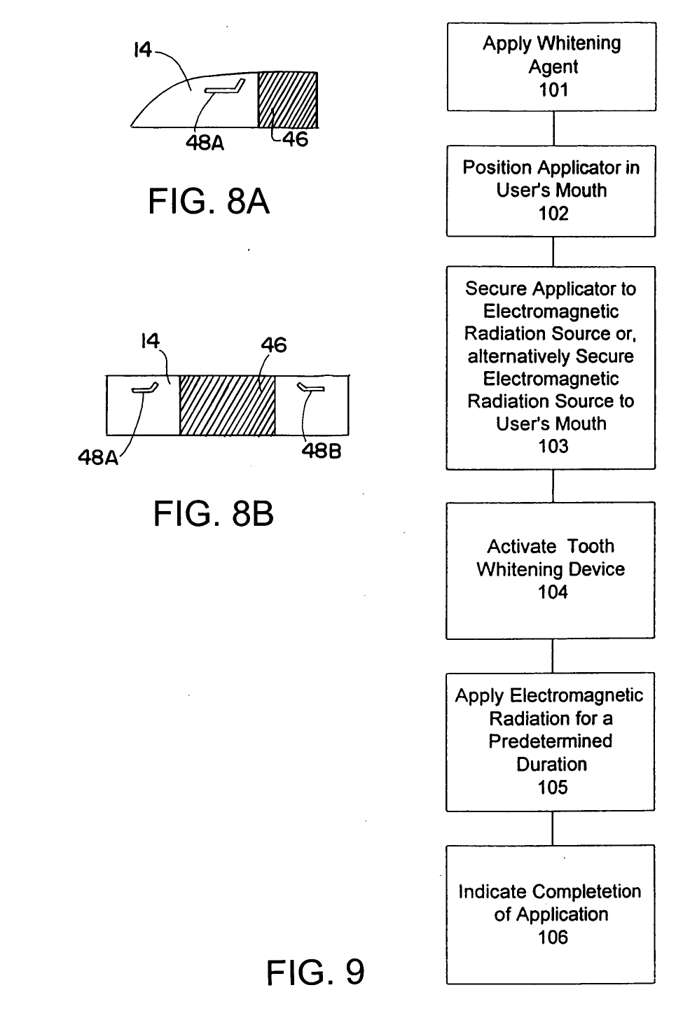

As stated above, the applicator 14 may include a reservoir 40 as shown in FIGS. 1A-1C and FIGS. 7A-7C. The reservoir 40 may be secured to the electromagnetic radiation source 12 by any connection known in the art (e.g., interference fit or a locking mechanism that engages when electromagnetic radiation source 12 is properly inserted therein). The applicator 14 may be transparent or include a window portion that permits exposure of the electromagnetic radiation to reach the user—s teeth. The applicator 14 may also include connection mechanisms 48A and 48B (shown in FIGS. 8A-8B), which interlock with connection mechanisms 38A-38B located on the electromagnetic radiation source 12, as shown in FIG. 2A.

In use, a whitening agent is applied to the teeth of the person desiring to have whiter teeth. The application of the whitening agent may take a variety of forms (e.g., depositing the tooth whitening agent 16 into the reservoir of a mouthpiece, using a brush to directly apply the tooth whitening agent 16 to the user's teeth).

The tooth whitening agent 16 may also take many forms. For instance, the tooth whitening agent 16 may be a gel, paste or a liquid, including toothpaste that apply a tooth whitening agent to the teeth. A tooth whitening agent 16 may be any liquid, powder or solid that imparts a tooth whitening effect on the user's teeth upon exposure. Common teeth whitening agents include hydrogen peroxide and carbamide peroxide. Generally, the tooth whitening agent 16 is diluted to lessen the harmful effects due to prolonged exposure to the chemical composition and possible risks due to ingestion. Depending on the precise tooth whitening agent 16 being used, the concentration of such tooth whitening agent 16 may range from about 1% to 15%.

The tooth whitening agent 16 may be provided in small plastic syringes, packets or in concentrated form. In one aspect of the invention, the tooth whitening agent 16 is provided in the form of a small plastic syringe that may injected or deposited onto the applicator 14. The syringe may contain suitable amounts of tooth whitening agent 16 for a single application or multiple applications.

A method of using the compact both whitening device 10 according to one aspect of the present invention is illustrated in FIG. 9. In operation, the user deposits a sufficient amount of tooth whitening agent 16 to coat or bathe the tooth or teeth the user desires to whiten on the applicator 14, as depicted in block 101. The applicator 14 is then placed in the user's mouth, as depicted in block 102. The electromagnetic radiation source 12 may then be secured either to the applicator 14 or to the user's mouth through the bite piece 42, as depicted in block 103. The user may press the activation switch 22 (block 104), which activates the electromagnetic radiation source 12. Upon initiation, a visual indication means 28, generally in the form of one or more lights, indicates that the electromagnetic radiation source 12 is to begin the application. The user may then press the activation switch 22 and/or start switch 44 which initiates a timed sequence depending at least in part on the type of tooth whitening agent 16 and/or the electromagnetic radiation emitter(s) 20 being used, as shown in block 105. In one embodiment, the user may vary the duration of the timed sequence. In another embodiment, the compact tooth whitening device 10 is operable for a predetermined duration to obtain optimum tooth whitening results (e.g., 30 seconds, 1, 2, 3 minutes, etc.). Upon completion of the application, a red visual light or (LED) may be illuminated, which indicates that the process has been completed, as depicted in block 106. In addition, to the visual indication means 28, or in lieu thereof, an audible indication means 26 may perform one more of the functions discussed for the visual indication means 26. For instance, the audible indication means 26 may provide a tone for each stage of the process (e.g., power on, process initiated, process completed). In addition, a unique tone may be provided for indicating each process step. Alternatively, a single tone may be provided to indicate the end of the application.

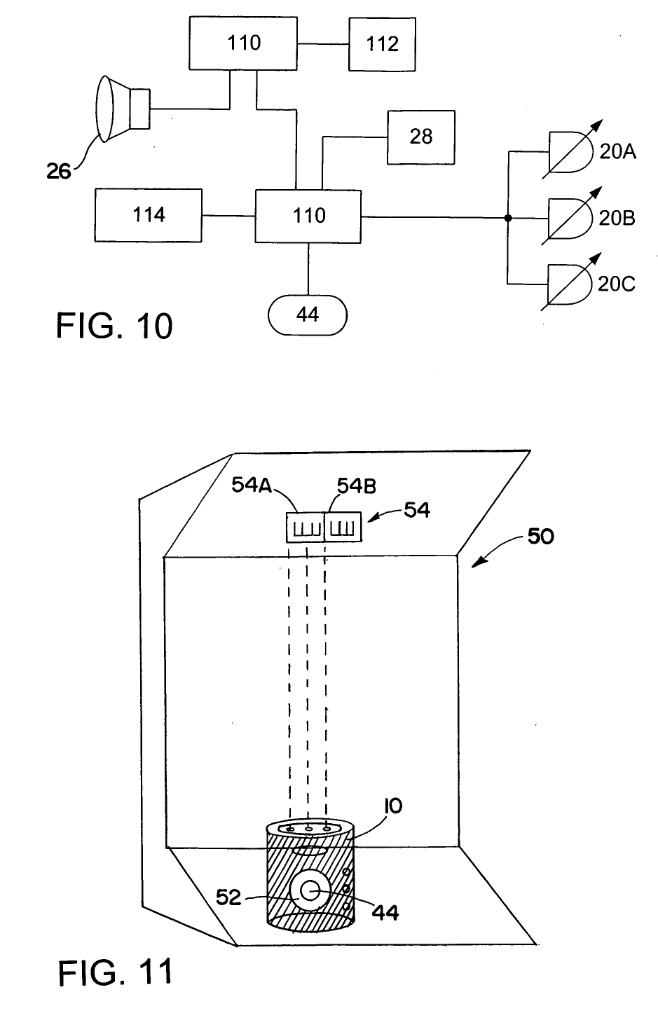

A functional block diagram of one aspect of the present invention is illustrated in FIG. 10. Upon pressing the start button 44 (or the activation switch 22 (not shown)), power is supplied to the compact tooth whitening device 10 by the power supply 114. The visual indication means 28 may receive a control signal from the driver 108. The visual indication means 28 may change colors or illuminate a different light and/or turn a different color. For instance, upon power being provided to the electromagnetic radiation source 12, a green visual indication light (or LED) may be illuminated. Upon pressing the start button 44 (or the activation switch 22 (not shown)), a yellow visual indication light (LED) may be illuminated, which may indicate that the whitening application is in process. In turn, the electromagnetic emitters 20A-20C receive a control signal from the driver 108 and emit electromagnetic radiation for a period of time.

In one aspect of the invention, a timer 110 sets the duration of the tooth whitening application. Generally the timer is preconfigured to provide an optimum duration for the tooth whitening application. In one embodiment, the timer 110 may be adjusted by a suitable adjustment mechanism 112 (e.g., a dial). In one aspect of the present invention a microcontroller (not shown) may be used to provide any or all of the functionality described herein.

Another aspect of the present invention relates to a “try me” package 46 for the compact tooth whitening device 10. As shown in FIG. 11, the tooth whitening device 10 may be sold in packaging 50 that allows the user to perform a limited number of functions (e.g., a demonstration mode that allows the user to press the start button 44 of the tooth whitening device 10). In such a case, an opening 52 may be provided in the otherwise secure package 50. Upon pressing the start button 44, the electromagnetic radiation emitter(s) 20 may be illuminated to emit electromagnetic radiation on a treated portion 54 of the package 50. Upon exposure to the electromagnetic radiation, a least a portion of the treated portion 54, which may display a discolored tooth or teeth, is shown to transform the discolored tooth or teeth into a whiter shade. The treated portion 54 may include a treated section 54A and an untreated section 54B to allow a viewer to make a comparison of the whitening effect of the compact tooth whitening device 10 before and after application of the electromagnetic radiation provided by the compact tooth whitening device 10.

As one of ordinary skill in the art will appreciate, the example system and method described herein can be modified. For example, certain steps can be omitted, certain steps can be carried out concurrently, and other steps can be added. Although particular embodiments of the invention have been described in detail, it is understood that the invention is not limited correspondingly in scope, but includes all changes, modifications and equivalents coming within the spirit and terms of the claims appended hereto.

What is claimed is:

1. A compact tooth whitening device comprising:
a compact electromagnetic radiation source including a body, at least one electromagnetic radiation emitter and a power supply;
an applicator for placing a tooth whitening agent on at least one tooth of an associated user, wherein the applicator allows electromagnetic energy generated by the at least one electromagnetic radiation emitter to permit a reaction with the tooth whitening agent in order to whiten the at least one tooth of the associated user.

2. The compact tooth whitening device of claim 1 wherein the applicator is secured to the body of the electromagnetic radiation source.

3. The compact tooth whitening device of claim 1 wherein the applicator is removably attached to the body of the electromagnetic radiation source.

4. The compact tooth whitening device of claim 1, wherein the compact electromagnetic radiation source further includes a waveguide.

5. The compact tooth whitening device of claim 4, wherein the waveguide is removably attached to the compact electromagnetic radiation source.

6. The compact tooth whitening device of claim 4 further including a waveguide attached to the electromagnetic radiation source.

7. The compact tooth whitening device of claim 6 wherein the applicator is connected to the waveguide.

8. The compact tooth whitening device of claim 6 wherein the applicator is removably attached to the waveguide.

9. The compact tooth whitening device of claim 1 wherein the tooth whitening agent is comprised from a member of the group of hydrogen peroxide, carbamide peroxide, or combinations thereof.

10. The compact tooth whitening device of claim 1 wherein the power source is a battery.

11. The compact tooth whitening device of claim 10 wherein the battery is rechargeable.

12. The compact tooth whitening device of claim 1, wherein the electromagnetic radiation emitter is a light emitting diode.

13. The compact tooth whitening device of claim 1, wherein the light emitting diode produces electromagnetic radiation at a wavelength in the range of about 300-700 nanometers.

14. The compact tooth whitening device of claim 1, wherein the light emitting diode operates in the range of about 130-160 milliwatts.

15. The compact tooth whitening device of claim 1, further including a signaling means for indicating completion of an application.

16. The compact tooth whitening device of claim 15, wherein the signaling means includes at least one of an audible sound or visual indication.

17. The compact tooth whitening device of claim 1, wherein the applicator is a mouthpiece.

18. A tooth whitening method comprising:
depositing a tooth whitening agent on an applicator;
securing the applicator in an associated user's mouth, whereby the applicator coats at least one tooth desired to be whitened;
securing a compact electromagnetic radiation source to the applicator, wherein the compact electromagnetic radiation source includes at least one electromagnetic radiation emitter and a power supply;
exposing the at least one tooth desired to be treated with electromagnetic radiation generated from the at least one electromagnetic radiation emitter, wherein the applicator permits the electromagnetic radiation generated by the at least one electromagnetic radiation emitter to cause a reaction with the tooth whitening agent in order to whiten the at least one tooth of the associated user.

19. The method of claim 18, wherein the at least one electromagnetic radiation emitters produces electromagnetic radiation at a wavelength in the range of about 300-700 nanometers.

20. The method of claim 18 further including indicating at least one of a beginning or completion of the tooth whitening process.

21. The method of claim 18, wherein the step of indicating at least one of a beginning or completion of the tooth whitening process is indicated by at least one of an audible or visual means.

22. A compact tooth whitening device comprising:
a compact electromagnetic radiation source including a body, at least one electromagnetic radiation emitter and a power supply, wherein the electromagnetic radiation emitter emits electromagnetic radiation in a range of wavelengths consisting of 300-700 nanometers;
an applicator for placing a tooth whitening agent on at least one tooth of an associated user, wherein the applicator allows electromagnetic energy generated by the at least one electromagnetic radiation emitter to permit a reaction with the tooth whitening agent in order to whiten the at least one tooth of the associated user, wherein the tooth whitening agent is selected based upon the wavelength of electromagnetic radiation emitted from the electromagnetic radiation emitter.

23. A package comprising:
an enclosure for securely covering the tooth whitening device of claim 1,
an opening on a surface of the enclosure to allow manipulation by at least one hand of a prospective purchaser;
a treated portion of the enclosure being visible to the prospective purchaser, wherein upon exposure to the electromagnetic radiation provided by the electromagnetic radiation emitter, the treated portion of the enclosure becomes lighter than when not exposed to the electromagnetic radiation.
